(19) United States
(12) Patent Application Publication
(10) Pub. No.: US 2006/0293403 A1
(43) Pub. Date: Dec. 28, 2006

(54) Mixtures containing initiators which can be activated by actinic radiation and two and more component systems, method for the production and use thereof

(76) Inventors: Baumgart Hubert, Munster (DE); Meisenburg Uwe, Mannheim (DE); Weikard Jan, Odenthal (DE); Mechtel Markus, Bergisch-Gladbach (DE); Fischer Wolfgang, Meerbusch (DE)

Correspondence Address: BASF CORPORATION, 1609 BIDDLE AVENUE, WYANDOTTE, MI, 48192, US

(21) Appl. No.: 10/552,259

(22) PCT Filed: Mar. 11, 2004
(86) PCT No.: PCT/EP04/02475

§ 371 Date: May 31, 2006

(30) Foreign Application Priority Data
Apr. 12, 2003 (DE) 10316890.7

(51) Int. Cl. C08F 2/50

(52) U.S. Cl. 522/6

(57) ABSTRACT

Mixtures free of isocyanate-reactive functional groups, containing isocyanate groups and no groups activable with actinic radiation or isocyanate groups and groups activable with actinic radiation as the sole or predominant reactive functional groups; and also at least one initiator activable by actinic radiation; and two-component or multi-component systems comprising initiators activable by actinic radiation; processes for preparing them, and their use.

The present invention relates to new mixtures and to new two-component and multicomponent systems which comprise initiators activable with actinic radiation. The present invention also relates to a new process for preparing two-component and multicomponent systems which comprise initiators activable with actinic radiation. The present invention further relates to the use of the new mixtures comprising activators activable with actinic radiation as crosslinking components in two-component and multicomponent systems. The present invention additionally relates to the use of the new two-component and multicomponent systems comprising initiators activable with actinic radiation for preparing compositions curable thermally and with actinic radiation, particularly for use as coating materials, adhesives, and sealants, and also as precursors of films and moldings for producing coatings, adhesive bonds, seals, films, and moldings.

Actinic radiation here and below means high-energy electromagnetic radiation, such as near infrared (NIR), visible light, UV radiation, X-rays or gamma radiation, especially UV radiation, and high-energy corpuscular radiation, such as electron beams, beta radiation, proton beams, neutron beams or alpha radiation, especially electron beams.

The curing of curable compositions by the combined effect of heat and actinic radiation is also referred to by those in the art as dual cure.

Two-component and multicomponent systems which comprise initiators activable with actinic radiation and serve to produce dual cure compositions are known.

Thus the American patent U.S. Pat. No. 4,342,793 A discloses a dual cure composition comprising as isocyanate-reactive constituents saturated polyols, such as hydroxy-functional (meth)acrylate (co)polymers, reactive diluents activable with actinic radiation, such as 1,6-hexanediol diacrylate, initiators activable by UV radiation, such as benzoin, benzoin ethers, Michler's ketone or chlorinated polycyclic aromatic hydrocarbons, and polyisocyanates.

Owing to the high reactivity of the polyisocyanates such curable compositions are known not to have long storage lives, pot lives or processing times, and so the polyisocyanates must be stored separately from the constituents containing isocyanate-reactive functional groups up until the time of processing. The resultant systems are therefore referred to as two-component or multicomponent systems.

From column 10 lines 7 to 29 in conjunction with column 13 lines 31 to 33, and column 14 lines 32 to 34, of U.S. Pat. No. 4,342,793 A it is apparent that the initiators activable with actinic radiation are used in conjunction with the reactive diluents activable with actinic radiation.

These known dual cure compositions exhibit a high reactivity and a high crosslinking rate, something which taken in isolation would be an advantage. Their storage stability, however, is impaired. In order to prevent the dual cure compositions polymerizing even before the polyisocyanates are added, free-radical polymerization inhibitors are added to the mixtures of reactive diluents and polyols. These inhibitors may, however, lead to unwanted secondary reactions, which adversely affect the curing of the dual cure compositions and hence also the properties of the cured compositions produced from them.

Comparable two-component and multicomponent systems are disclosed by German patent application DE 198 18 735 A1. They comprise compounds A), which contain free-radically polymerizable double bonds and, for example, hydroxyl or isocyanate groups, compounds B), which contain free-radically polymerizable double bonds and, for example, the complementary isocyanate or hydroxyl groups, and photoinitiators D). Compounds A) and B) must be stored separately from one another, i.e., as different components. DE 198 18 735 A1 does not reveal whether the photoinitiators D) are already present in one of the components before the components are mixed, and, if so, in which component, or whether they are added only to the dual cure compositions resulting from the mixing process.

Furthermore, German patent application DE 198 00 528 A1 and European patent application EP 1 085 065 A2 disclose dual cure compositions composed of
a) a urethane (meth)acrylate containing (meth)acryloyl groups and free isocyanate groups,
b) if desired, a further polyisocyanate,
c) a UV initiator of free-radical polymerization, and
d) one or more isocyanate-reactive compounds, such as saturated polyols.

The dual cure compositions are preferably prepared as two-component systems. In that case component (I) contains constituents (a)+(b), and component (II) contains constituents (c)+(d). As far as their crosslinking rate and the crosslinking density of the cured compositions produced from them, however, these known dual cure compositions leave much to be desired.

There is therefore a need for two-component or multicomponent systems which on the one hand are particularly stable on storage and on the other hand produce dual cure compositions which cure rapidly to form defect-free cured compositions.

This need is particularly pressing in the field of automotive OEM finishing, since here the requirements on the storage stability of the two-component or multicomponent systems and on the quality of the coatings produced from them are particularly exacting. For instance, the components must be able to be stored for several months at room temperature or even above, at up to 40° C., without suffering any deterioration in their technological properties. Such high storage temperatures and long storage times occur in particular in the course of container shipping in the summer. In the painting plant in the circuits, conveying equipment, such as gear pumps, and/or during the grinding of pigmented components in milling units, the components must also withstand high and also lasting shear forces, which may lead to an increase in the temperature of the components locally or in their entirety, and must do so without any adverse change in the technological properties, as a result of premature polymerization, for instance. The damage due to thermal and mechanical exposure may be exacerbated by exposure to light.

It is an object of the present invention to provide new two-component or multicomponent systems comprising at least one initiator activable by actinic radiation and composed of
(I) at least one component free of isocyanate groups, containing groups activable with actinic radiation and isocyanate-reactive functional groups as the sole or predominant reactive functional groups and
(II) at least one component free of isocyanate-reactive functional groups and containing
   isocyanate groups and no groups activable with actinic radiation or
   isocyanate groups and groups activable with actinic radiation
as the sole or predominant reactive functional groups,
   which systems no longer have the disadvantages of the prior art but instead whose components (I) can be stored for a long time even at relatively high temperatures, such as occur in the course of their container shipping in the summer, without losing their technological properties and are able to withstand even high and lasting shear forces, such as occur in the course of their processing in particular in the painting plant in circuits, in conveying equipment, such as gear pumps, and/or during the grinding of pigmented components (I) in milling units and lead to an increase in the temperature of the components locally or overall. All in all there should be no deleterious change in the technological properties of their components (I) on mechanical and/or thermal exposure, not even in combination with exposure to light.

The new two-component or multicomponent systems comprising initiator activable by actinic radiation are intended to provide dual cure compositions suitable in particular as coating materials, adhesives, and sealants and also as precursors of films and moldings. The new dual cure compositions are intended to be curable easily and rapidly to form cured compositions, especially coatings, adhesive bonds, seals, films, and moldings, which are free from defects and exhibit outstanding performance properties.

The invention accordingly provides the new mixtures, free from isocyanate-reactive functional groups, which contain
isocyanate groups and no groups activable with actinic radiation or
isocyanate groups and groups activable with actinic radiation
   as the sole or predominant reactive functional groups and also at least one initiator activable by actinic radiation, which are referred to below as “mixtures of the invention”.

The invention also provides for the new use of the mixtures of the invention as crosslinking components (components II), of two-component or multicomponent systems.

The invention further provides the new two-component or multicomponent systems which comprise at least one initiator activable by actinic radiation and are composed of
(I) at least one component free of isocyanate groups, containing groups activable with actinic radiation and isocyanate-reactive functional groups as the sole or predominant reactive functional groups and
(II) at least one component free of isocyanate-reactive functional groups and containing
   isocyanate groups and no groups activable with actinic radiation or
   isocyanate groups and groups activable with actinic radiation,
      in which all or most of the initiator activable with actinic radiation is present in component(s) (II).

The new two-component or multicomponent systems comprising at least one initiator activable by actinic radiation are referred to collectively below as “systems of the invention”.

The invention additionally provides the new process for preparing two-component or multicomponent systems comprising at least one initiator activable by actinic radiation and composed of
(I) at least one component free of isocyanate groups, containing groups activable with actinic radiation and isocyanate-reactive functional groups as the sole or predominant reactive functional groups and
(II) at least one component free of isocyanate-reactive functional groups and containing
   isocyanate groups and no groups activable with actinic radiation or
   isocyanate groups and groups activable with actinic radiation
as the sole or predominant reactive functional groups
   by separately preparing components (I) and (II), wherein all or most of the initiator activable by actinic radiation is added to component(s) (II).

The new process for preparing two-component or multicomponent systems comprising at least one initiator activable by actinic radiation is referred to below as “process of the invention”.

The invention provides, moreover, for the use of the systems of the invention for preparing dual cure compositions comprising groups activable with actinic radiation, isocyanate-reactive functional groups, and isocyanate groups as the sole or predominant reactive functional groups and also at least one initiator activable by actinic radiation.

Further subject matter of the invention is apparent from the description.

In the light of the prior art it was surprising and unforeseeable for the skilled worker that the object on which the present invention is based could be achieved by means of the mixtures of the invention, the systems of the invention, the process of the invention, and the uses thereof in accordance with the invention.

This is surprising in particular since it was to have been expected that the highly reactive free isocyanate groups of the mixtures of the invention and of components (II) of the systems of the invention would enter into unwanted reactions with the initiators activable with actinic radiation in the course of the preparation, storage and processing of the mixtures of the invention and of components (II) of the systems of the invention.

More particularly it was surprising that components (I) of the systems of the invention could be stored for a long time even at relatively high temperatures, such as occur during their container shipping in the summer, for example, without loss of their technological properties and withstood even high and lasting shear forces, such as occur during their processing in particular in the painting plant in circuits, in conveying equipment, such as gear pumps, and/or during the grinding of pigmented components (I) in milling units, leading to an increase in the temperature of the components (I) locally or overall. All in all there was no deleterious change in the technological properties of the components (I) on mechanical and/or thermal exposure, not even when combined with exposure to light.

The systems of the invention gave dual cure compositions of the invention which were suitable in particular as coating materials, adhesives, and sealants and also as precursors of films and moldings. The dual cure compositions of the invention could be cured easily and rapidly to form cured compositions of the invention, especially coatings, adhesive bonds, seals, films, and moldings, which were free from defects and exhibited outstanding performance properties.

The mixtures and systems of the invention, and components (I) and (II), are liquid. This means that components (I) and the mixtures of the invention or components (II) are aqueous, organic and/or aqueous-organic molecularly disperse solutions and/or dispersions. Preferably components (I) and (II) contain their constituents in the form of molecularly disperse solutions and/or dispersions in organic solvents.

It is preferred to employ inert, i.e., non-isocyanate-reactive, organic solvents which do not inhibit the dual cure of the dual cure compositions of the invention and/or do not enter into any disruptive interactions with constituents of the dual cure compositions of the invention. The skilled worker is therefore able to select suitable solvents with ease on the basis of their known solvency and reactivity.

Examples of suitable solvents are known from D. Stoye and W. Freitag (editors), “Paints, Coatings and Solvents”, Second, Completely Revised Edition, Wiley-VCH, Weinheim, New York, 1998, “14.9. Solvent Groups”, pages 327 to 373.

The mixtures of the invention can be put to a very wide variety of uses. They are used with preference as crosslinking components (components II) in the systems of the invention. The mixtures of the invention are therefore described in detail below in connection with components II of the systems of the invention. The comments made in that description apply analogously to the mixtures of the invention.

The solids content of the components (I) of the systems of the invention, i.e., the amount they contain of constituents which following the preparation and curing of the dual cure compositions of the invention form part of the dually cured compositions of the invention, may vary very widely and is guided in particular by the reactivity and solubility and/or dispersibility of the constituents, the number of reactive functional groups they contain, and the desired viscosity of components (I). The solids content of components (I) is preferably from 5 to 90%, more preferably from 10 to 80%, with particular preference from 15 to 75%, with very particular preference from 20 to 70%, and in particular from 25 to 65% by weight, based in each case on component (I).

The solids content of components (II), i.e., the amount therein of constituents which following the preparation and curing of the dual cure compositions of the invention form part of the dually cured compositions of the invention, may also vary very widely. It too is guided in particular by the reactivity and solubility and/or dispersibility of the constituents, the number of reactive functional groups they contain, and the desired viscosity of components (II). The solids content of components (II) is preferably from 5 to 90%, more preferably from 10 to 80%, with particular preference from 15 to 75%, with very particular preference from 20 to 70%, and in particular from 25 to 65% by weight, based in each case on component (II).

The systems of the invention are two-component and multicomponent systems.

The multicomponent systems are composed of at least one component (I) free of isocyanate groups and at least two components (II) free of isocyanate-reactive functional groups or of at least two components (I) free of isocyanate groups and at least one component (II) free of isocyanate groups. The systems of the invention are preferably two-component systems, composed of one component (I) and one component (II).

The systems of the invention include at least one initiator activable by actinic radiation. It is preferred to use at least two, preferably two or three, initiators.

The initiator is activated by high-energy electromagnetic radiation, such as near infrared (NIR), visible light, UV radiation, X-rays or gamma radiation, especially UV radiation, and high-energy corpuscular radiation, such as electron beams, beta radiation, proton beams, neutron beams or alpha radiation, especially electron beams, and thereby initiates curing by way of the groups activable with actinic radiation that are present in the dual cure compositions of the invention.

The initiators are preferably photoinitiators. The photoinitiator or photoinitiators is or are selected preferably from the group consisting of unimolecular (type I) and bimolecular (type II) photoinitiators. With particular preference the photoinitiators of type I are selected from the group consisting of benzophenones in combination with tertiary amines, alkylbenzophenones, 4,4′-bis(dimethylamino)benzophenone (Michler's ketone), anthrone, and halogenated benzophenones, and the photo-initiators of type II from the group consisting of benzoins, benzoin derivatives, especially benzoin ethers, benzil ketals, acylphosphine oxides, especially 2,4,6-trimethylbenzoyldiphenylphosphine oxide, bisacylphosphine oxides, phenyl-glyoxylic esters, camphorquinone, alpha-aminoalkylphenones, alpha, alpha-dialkoxyacetophenones, and alpha-hydroxyalkylphenones.

In accordance with the invention most, i.e., more than 50% by weight, of the initiator activable with actinic radiation that is present in each case, or all of it, especially all of it, is present in component(s) (II). The amount of initiator in component(s) (II) may vary widely and is guided primarily by the amount of initiator necessary and/or advantageous for the actinic radiation curing of the dual cure compositions of the invention prepared from the component(s) (II) in question. This amount is preferably from 0.1 to 15%, more preferably from 0.2 to 12%, with particular preference from 0.3 to 10%, with very particular preference from 0.4 to 0.8%, and in particular from 0.5 to 7% by weight, based in each case on the solids of the dual cure composition of the invention.

Component (I) is free of isocyanate groups. It contains groups activable with actinic radiation and isocyanate-reactive functional groups.

The groups activable with actinic radiation contain at least one, especially one, bond which can be activated with actinic radiation.

For the purposes of the present invention a bond which can be activated with actinic radiation is a bond which on exposure to actinic radiation becomes reactive and, with other activated bonds of its kind, enters into polymerization reactions and/or crosslinking reactions which proceed in accordance with free-radical and/or ionic mechanisms.

The bonds which can be activated with actinic radiation are preferably selected from the group consisting of carbon-hydrogen and carbon-halogen single bonds, carbon-carbon, carbon-oxygen, carbon-nitrogen, carbon-phosphorus, and carbon-silicon single bonds and double bonds, and carbon-carbon triple bonds. In particular the bonds which can be activated with actinic radiation are carbon-carbon double bonds (“double bonds”). The double bonds are present preferably in groups activable with actinic radiation, selected from the group consisting of (meth)acrylate, ethacrylate, crotonate, cinnamate, vinyl ether, vinyl ester, dicyclopentadienyl, norbomenyl, isoprenyl, isopropenyl, allyl, and butenyl groups; dicyclopentadienyl ether, norbomenyl ether, isoprenyl ether, isopropenyl ether, allyl ether, and butenyl ether groups; and dicyclopentadienyl ester, norbornenyl ester, isoprenyl ester, isopropenyl ester, allyl ester, and butenyl ester groups. In particular the double bonds are acrylate groups.

The amount of groups activable with actinic radiation in components (I) may vary widely and is guided primarily by the reactivity of the groups and by the crosslinking density which is to be present in the dually cured compositions formed from the dual cure compositions of the invention prepared with the aid of the components (I) in question. This amount is preferably from 1 to 5, more preferably from 1.5 to 4, and in particular from 2 to 3 meq/g.

The isocyanate-reactive functional groups are preferably selected from the group consisting of hydroxyl groups, thiol groups, primary and secondary amino groups, and imino groups. In particular hydroxyl groups are used.

The amount of isocyanate-reactive functional groups in components (I) may vary widely and is guided primarily by the reactivity of the groups and by the crosslinking density which is to be present in the dually cured compositions of the invention formed from the dual cure compositions of the invention prepared with the aid of the components (I) in question. This amount is preferably from 1 to 5, more preferably from 1.5 to 4, and in particular from 2 to 3 meq/g.

The above-described groups curable with actinic radiation and the isocyanate-reactive functional groups are the sole or predominant reactive functional groups in component (I). “Predominant” means that the reactive functional groups in question make up more than 50, preferably more than 60, and in particular more than 70 equivalent %, based in each case on all of the reactive functional groups present in component (I).

The additional reactive functional groups, other than the reactive functional groups described above, where present, are preferably thermally activable reactive functional groups, such as carboxyl groups, methylol ether groups, epoxide groups and/or blocked isocyanate groups, such as are normally used in one-component systems.

The above-described groups activable with actinic radiation and the isocyanate-reactive functional groups can be present in any of a very wide variety of the constituents of components (I).

The two kinds of groups may be present for instance in low molecular mass, oligomeric and/or polymeric constituents which are one and the same. The groups activable with actinic radiation, on the one hand, and the isocyanate-reactive functional groups, on the other, may also be present in different low molecular mass, oligomeric and/or polymeric constituents which are free of the respective other groups. The selection of the constituents is guided primarily by the target performance profile of properties of the dually cured compositions of the invention formed from the relevant dual cure compositions of the invention prepared with the aid of components (I).

For the purposes of the present invention an oligomer is a compound generally containing on average from 2 to 15 basic structures or monomer units. A polymer, on the other hand, is a compound generally containing on average at least 10 basic structures or monomer units. Compounds of this kind are also referred to by those skilled in the art as binders or resins.

In contradistinction thereto a low molecular mass compound for the purposes of the present invention is a compound derived essentially only from one basic structure or one monomer unit. Compounds of this kind are also referred to in general by those skilled in the art as reactive diluents.

Examples of suitable reactive diluents containing at least one, in particular at least two, bond(s) which can be activated with actinic radiation are olefinically unsaturated monomers, preferably vinylaromatic monomers and acrylates, especially acrylates, having at least one free-radically polymerizable double bond and preferably at least two, more preferably at least three, with particular preference at least four, and in particular at least five free-radically polymerizable double bonds. Suitable reactive diluents are described in detail in Römpp Lexikon Lacke und Druckfarben, Georg Thieme Verlag, Stuttgart, New York, 1998, “Reactive diluents”, pages 491 and 492, in German patent application DE 199 08 013 A1, column 6 line 63 to column 8 line 65, in German patent application DE 199 08 018 A1, page 11 lines 31 to 33, in German patent application DE 198 18 735 A1, column 7 lines 1 to 35, or in German patent DE 197 09 467 C1, page 4 line 36 to page 5 line 56. It is preferred to use pentaerythritol tetraacrylate and/or dipentaerythritol pentaacrylate.

Suitable polymers or oligomers used as binders and containing at least one, in particular at least two, bond(s) which can be activated by actinic radiation normally have a number-average molecular weight of from 500 to 50 000, preferably from 1 000 to 5 000. They preferably have a double bond equivalent weight from 400 to 2 000, more preferably from 500 to 900. In addition they preferably have a viscosity at 23° C. of from 250 to 11 000 mPas. In components (I) they are preferably used in an amount such that the dual cure compositions of the invention prepared therefrom have a binder content of from 5 to 50% by weight, more preferably from 6 to 45% by weight, with particular preference from 7 to 40% by weight, with very particular preference from 8 to 35% by weight, and in particular from 9 to 30% by weight, based in each case on the solids of the dual cure composition of the invention.

Examples of suitable binders or resins come from the oligomer and/or polymer classes of the (meth)acryloyl-functional (meth)acrylic copolymers, polyether acrylates, polyester acrylates, polyesters, epoxy acrylates, urethane acrylates, amino acrylates, melamine acrylates, silicone acrylates, and phosphazene acrylates, and the corresponding methacrylates. It is preferred to use binders which are free of aromatic structural units. Preference is therefore given to using urethane (meth)acrylates, phosphazene (meth)acrylates and/or polyester (meth)acrylates, with particular preference urethane (meth)acrylates, especially aliphatic urethane (meth)acrylates.

The urethane (meth)acrylates are obtained by reacting a diisocyanate or polyisocyanate with a chain extender from the group of the diols/polyols and/or diamines/polyamines and/or dithiols/polythiols and/or alkanolamines and then reacting the remaining free isocyanate groups with at least one hydroxyalkyl (meth)acrylate or hydroxyalkyl ester of other ethylenically unsaturated carboxylic acids.

The amounts of chain extenders, diisocyanates or polyisocyanates, and hydroxyalkyl esters in this case are preferably chosen so that
1.) the equivalents ratio of the NCO groups to the reactive groups of the chain extender (hydroxyl, amino and/or mercaptyl groups) is between 3:1 and 1:2, and more preferably is 2:1, and
2.) the OH groups of the hydroxyalkyl esters of the ethylenically unsaturated carboxylic acids are stoichiometric with regard to the remaining free isocyanate groups of the prepolymer formed from isocyanate and chain extender.

It is also possible to prepare the urethane (meth)acrylates by first reacting some of the isocyanate groups of a diisocyanate or polyisocyanate with at least one hydroxyalkyl ester and then reacting the remaining isocyanate groups with a chain extender. In this case too the amounts of chain extender, isocyanate, and hydroxyalkyl ester are chosen such that the equivalents ratio of the NCO groups to the reactive groups of the chain extender is between 3:1 and 1:2, and is preferably 2:1, and the equivalents ratio of the remaining NCO groups to the OH groups of the hydroxyalkyl ester is 1:1. All of the forms lying between these two processes are of course also possible. For example, some of the isocyanate groups of a diisocyanate can first be reacted with a diol, after which a further fraction of the isocyanate groups can be reacted with the hydroxyalkyl ester, and, subsequently, the remaining isocyanate groups can be reacted with a diamine.

The urethane (meth)acrylates may be flexibilized, for example, by reacting corresponding isocyanate-functional prepolymers or oligomers with relatively long-chain aliphatic diols and/or diamines, especially aliphatic diols and/or diamines having at least 6 carbon atoms. This flexibilizing reaction may be carried out before or after the addition reaction of acrylic and/or methacrylic acid with the oligomers and/or prepolymers.

Examples of suitable urethane (meth)acrylates include the following, commercially available, polyfunctional, aliphatic urethane acrylates:
Crodamer® UVU 300 from Croda Resins Ltd, Kent, Great Britain;
Genomer® 4302, 4235, 4297 or 4316 from Rahn Chemie, Switzerland;
Ebecryl® 284, 294, IRR 351, 5129 or 1290 from UCB, Drogenbos, Belgium;
Roskydal® LS 2989, LS 2337 or LS 2308 from Bayer AG, Germany;
Viaktin® VTE 6160 from Vianova, Austria; or
Laromer® 8861 from BASF AG, and experimental modifications thereof.

Hydroxyl-containing urethane (meth)acrylates, for example, are known from U.S. Pat. No. 4,634,602 A or U.S. Pat. No. 4,424,252 A.

Examples of suitable reactive diluents having at least one, in particular at least two, isocyanate-reactive functional group(s) are conventional alcohols, diols, and polyols.

Examples of suitable oligomeric or polymeric binders containing at least one, in particular at least two, isocyanate-reactive functional group(s) are linear and/or branched and/or block, comb and/or random oligomers or polymers, such as (meth)acrylate (co)polymers, polyesters, alkyds, amino resins, polyurethanes, polylactones, polycarbonates, polyethers, epoxy resin-amine adducts, (meth)acrylatediols, partially hydrolyzed polyvinyl esters or polyureas, of which the (meth)acrylate copolymers, the polyesters, the polyurethanes, the polyethers, and the epoxy resin-amine adducts, but particularly (meth)acrylate (co)polymers and polyesters, are advantageous.

Highly suitable (meth)acrylate copolymers have
an OH number of from 100 to 220, preferably from 130 to 200, more preferably from 140 to 190, and in particular from 145 to 180 mg KOH/g,
a glass transition temperature of from −35 to +60° C., in particular from −25 to +40° C.,
a number-average molecular weight of from 1 000 to 10 000 daltons, in particular from 1 500 to 5 000 daltons, and
a mass-average molecular weight of from 2 000 to 40 000 daltons, in particular from 3 000 to 20 000 daltons.

The (meth)acrylate copolymers contain in copolymerized form a quantity of hydroxyl-containing olefinically unsaturated monomers (a) which corresponds to their OH number, and of which
(a1) from 20 to 90%, preferably from 22 to 85%, more preferably from 25 to 80%, and in particular from 28 to 75% by weight, based in each case on the hydroxyl-containing monomers (a), are selected from the group consisting of 4-hydroxybutyl (meth)acrylate and 2-alkylpropane-1,3-diol mono(meth)acrylates and
(a2) from 15 to 80%, preferably from 20 to 78%, more preferably from 20 to 75%, and in particular from 25 to 72% by weight, based in each case on the hydroxyl-containing monomers (a), are selected from the group consisting of other hydroxyl-containing olefinically unsaturated monomers.

Examples of suitable 2-alkylpropane-1,3-diol mono(meth)acrylates (al) are 2-methyl-, 2-ethyl-, 2-propyl-, 2-isopropyl- or 2-n-butyl-propane-1,3-diol mono(meth)acrylate, of which 2-methylpropane-1,3-diol mono(meth)acrylate is particularly advantageous and is used with preference.

Examples of suitable other hydroxyl-containing olefinically unsaturated monomers (a2) are hydroxyalkyl esters of olefinically unsaturated carboxylic, sulfonic, and phosphonic acids and acidic phosphoric and sulfuric esters, especially carboxylic acids, such as acrylic acid, beta-carboxyethyl acrylate, methacrylic acid, ethacrylic acid, and crotonic acid, especially acrylic acid and methacrylic acid. They are derived from an alkylene glycol, which is esterified with the acid, or are obtainable by reacting the acid with an alkylene oxide such as ethylene oxide or propylene oxide. It is preferred to use the hydroxyalkyl esters in which the hydroxyalkyl group contains up to 20 carbon atoms, especially 2-hydroxyethyl or 3-hydroxypropyl acrylate or methacrylate; 1,4-bis(hydroxymethyl)cyclohexane or octahydro-4,7-methano-1H-indenedimethanol monoacrylate or monomethacrylate; or reaction products of cyclic esters, such as epsilon-caprolactone, and these hydroxyalkyl esters; or olefinically unsaturated alcohols such as allyl alcohol; or polyols, such as trimethylolpropane monoallyl or diallyl ether or pentaerythritol monoallyl, diallyl or triallyl ether, are used. These higher polyfunctional monomers (a2) are generally used only in minor amounts. For the purposes of the present invention minor amounts of higher polyfunctional monomers (a2) are amounts which do not lead to crosslinking or gelling of the (meth)acrylate copolymers (A) unless the intention is that they should be in the form of crosslinked microgel particles.

Further suitable monomers (a2) include ethoxylated and/or propoxylated allyl alcohol, which is sold by Arco Chemicals, or 2-hydroxyalkyl allyl ethers, especially 2-hydroxyethyl allyl ether. Where used, they are employed not as sole monomers (a2) but in an amount of from 0.1 to 10% by weight, based on the (meth)acrylate copolymer.

Further suitable monomers (a2) include reaction products of the above-recited olefinically unsaturated acids, especially acrylic acid and/or methacrylic acid, with the glycidyl ester of an alpha-branched monocarboxylic acid having 5 to 18 carbon atoms per molecule, in particular a Versatic® acid, or, instead of the reaction products, an equivalent amount of the above-recited olefinically unsaturated acids, especially acrylic acid and/or methacrylic acid, which is then reacted, during or after the polymerization reaction, with the glycidyl ester of an alpha-branched monocarboxylic acid having 5 to 18 carbon atoms per molecule, in particular a Versatic® acid (cf. Römpp Lexikon Lacke und Druckfarben, Georg Thieme Verlag, Stuttgart, New York, 1998, “Versatic® acids”, pages 605 and 606).

Suitable not least as monomers (a2) are acryloyloxysilane-containing vinyl monomers preparable by reacting hydroxy-functional silanes with epichlorohydrin and then reacting that reaction product with (meth)acrylic acid and/or hydroxyalkyl and/or hydroxycycloalkyl esters of (meth)acrylic acid and/or other hydroxyl-containing monomers (a1) and (a2).

Besides the hydroxyl groups the (meth)acrylate copolymers may further include other isocyanate-reactive functional groups, such as primary and secondary amino groups.

As well as the above-described isocyanate-reactive functional groups the (meth)acrylate copolymers may include minor amounts of additional, thermally activable, reactive functional groups, such as carboxyl groups, methylol ether groups, epoxide groups and/or blocked isocyanate groups.

Examples of suitable olefinically unsaturated monomers (a3) which can be used to introduce isocyanate-reactive amino groups and additional, thermally activable, reactive functional groups into the (meth)acrylate copolymers are
(a31) monomers which carry at least one amino group per molecule, such as
   aminoethyl acrylate, aminoethyl methacrylate, allylamine or N-methylaminoethyl acrylate; and/or
(a32) monomers which carry at least one acid group per molecule, such as
   acrylic acid, beta-carboxyethyl acrylate, methacrylic acid, ethacrylic acid, crotonic acid, maleic acid, fumaric acid or itaconic acid;
   olefinically unsaturated sulfonic or phosphonic acids or their partial esters;
   mono(meth)acryloyloxyethyl maleate, succinate or phthalate; or
   vinylbenzoic acid (all isomers), alpha-methylvinylbenzoic acid (all isomers) or vinylbenzenesulfonic acid (all isomers); and/or
(a33) monomers containing epoxide groups, such as the glycidyl ester of acrylic, methacrylic, ethacrylic, crotonic, maleic, fumaric or itaconic acid or allyl glycidyl ether.

The (meth)acrylate copolymers may further contain in copolymerized form at least one olefinically unsaturated monomer (a4) which is substantially or entirely free from reactive functional groups, such as:

Monomers (a41):

Substantially acid-group-free (meth)acrylic esters such as (meth)acrylic alkyl or cycloalkyl esters having up to 20 carbon atoms in the alkyl radical, especially methyl, ethyl, n-propyl, n-butyl, sec-butyl, tert-butyl, hexyl, ethylhexyl, stearyl, and lauryl acrylate or methacrylate; cycloaliphatic (meth)acrylic esters, especially cyclohexyl, isobornyl, dicyclopentadienyl, octahydro-4,7-methano- 1H-indenemethanol or tert-butylcyclohexyl (meth)acrylate; (meth)acrylic oxaalkyl esters or oxacycloalkyl esters such as ethoxytriglycol (meth)acrylate and methoxyoligoglycol (meth)acrylate having a molecular weight Mn of preferably 550 or other ethoxylated and/or propoxylated, hydroxyl-free (meth)acrylic acid derivatives (further examples of suitable monomers (a41) of this kind are known from laid-open specification DE 196 25 773 A1, column 3 line 65 to column 4 line 20). They may contain, in minor amounts, higher polyfunctional (meth)acrylic alkyl or cycloalkyl esters such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate. Minor amounts of higher polyfunctional monomers (a41) here are amounts which do not lead to crosslinking or gelling of the copolymers unless the intention is that they should be in the form of crosslinked microgel particles.

Monomers (a42):

Vinyl esters of alpha-branched monocarboxylic acids having 5 to 18 carbon atoms in the molecule. The branched monocarboxylic acids can be obtained by reacting formic acid or carbon monoxide and water with olefins in the presence of a liquid, strongly acidic catalyst; the olefins may be products of the cracking of paraffinic hydrocarbons, such as mineral oil fractions, and may contain both branched and straight-chain acyclic and/or cycloaliphatic olefins. The reaction of such olefins with formic acid or with carbon monoxide and water produces a mixture of carboxylic acids in which the carboxyl groups are located predominantly on a quaternary carbon atom. Examples of other olefinic starting materials are propylene trimer, propylene tetramer, and diisobutylene. Alternatively the vinyl esters can be prepared conventionally from the acids, e.g., by reacting the acid with acetylene. Particular preference, owing to their ready availability, is given to using vinyl esters of saturated aliphatic monocarboxylic acids having 9 to 11 carbon atoms that are branched on the alpha carbon atom. Vinyl esters of this kind are sold under the brand name VeoVa®(cf. Römpp Lexikon Lacke und Druckfarben, Georg Thieme Verlag, Stuttgart, New York, 1998, page 598).

Monomers (a43):

Diarylethylenes, particularly those of the general formula I:
R¹R²C═CR³R⁴ (I),
in which the radicals R¹, R², R³, and R⁴ each independently of one another stand for hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ stand for substituted or unsubstituted aryl, arylalkyl or arylcycloalkyl radicals, especially substituted or unsubstituted aryl radicals. Examples of suitable alkyl radicals are methyl, ethyl, propyl, isopropyl, n-butyl, isobutyl, tert-butyl, amyl, hexyl or 2-ethylhexyl. Examples of suitable cycloalkyl radicals are cyclobutyl, cyclopentyl or cyclohexyl. Examples of suitable alkylcycloalkyl radicals are methylenecyclohexane, ethylenecyclohexane or propane-1,3-diylcyclohexane. Examples of suitable cycloalkylalkyl radicals are 2-, 3- or 4-methyl-, -ethyl-, -propyl- or -butylcyclohex-1-yl. Examples of suitable aryl radicals are phenyl, naphthyl or biphenylyl, preferably phenyl and naphthyl, and especially phenyl. Examples of suitable alkylaryl radicals are benzyl or ethylene-or propane-1,3-diyl-benzene. Examples of suitable cycloalkylaryl radicals are 2-, 3- or 4-phenylcyclohex-1-yl. Examples of suitable arylalkyl radicals are 2-, 3-or 4-methyl-, -ethyl-, -propyl- or -butylphen-1-yl. Examples of suitable arylcycloalkyl radicals are 2-, 3- or 4-cyclohexylphen-1-yl. The aryl radicals R¹, R², R³ and/or R⁴ are preferably phenyl or naphthyl radicals, especially phenyl radicals. The substituents possibly present in the radicals R¹, R², R³ and/or R⁴ are electron-withdrawing or electron-donating atoms or organic radicals, especially halogen atoms, nitrile, nitro, partially or fully halogenated alkyl, cycloalkyl, alkylcycloalkyl, cycloalkylalkyl, aryl, alkylaryl, cycloalkylaryl, arylalkyl, and arylcycloalkyl radicals; aryloxy, alkyloxy, and cycloalkyloxy radicals; and/or arylthio, alkylthio, and cycloalkylthio radicals. Particular advantage is possessed by diphenylethylene, dinaphthaleneethylene, cis- or trans-stilbene or vinylidenebis(4-nitrobenzene), especially diphenylethylene (DPE), and so they are used with preference. For the purposes of the present invention the monomers (a43) are used in order to regulate the copolymerization advantageously such that a batchwise free-radical copolymerization is also possible.
Monomers (a44):

Vinylaromatic hydrocarbons such as styrene, vinyltoluene, diphenylethylene or alpha-alkylstyrenes, especially alpha-methylstyrene.

Monomers (a45):

Nitriles such as acrylonitrile and/or methacrylonitrile.

Monomers (a46):

Vinyl compounds, especially vinyl halides and/or vinylidene dihalides such as vinyl chloride, vinyl fluoride, vinylidene dichloride or vinylidene difluoride; N-vinylamides such as vinyl-N-methylformamide, N-vinylcaprolactam or N-vinylpyrrolidone; 1-vinylimidazole; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.

Monomers (a47):

Allyl compounds, especially allyl ethers and allyl esters such as allyl methyl, ethyl, propyl or butyl ether or allyl acetate, propionate or butyrate.

Monomers (a48):

Polysiloxane macromonomers which have a number-average molecular weight Mn of from 1000 to 40 000 and contain on average from 0.5 to 2.5 ethylenically unsaturated double bonds per molecule; especially polysiloxane macromonomers which have a number-average molecular weight Mn of from 2000 to 20 000, with particular preference from 2500 to 10 000, and in particular from 3000 to 7000 and contain on average from 0.5 to 2.5, preferably from 0.5 to 1.5, ethylenically unsaturated double bonds per molecule, as described in DE 38 07 571 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1 or in international patent application WO 92/22615 on page 12 line 18 to page 18 line 10.

The monomers (a1) and (a2) and also (a3) and/or (a4) are selected so as to result in the OH numbers and glass transition temperatures indicated above.

The selection of the monomers (a) for adjusting the glass transition temperatures can be undertaken by the skilled worker with the assistance of the following formula of Fox, by which the glass transition temperatures of poly(meth)acrylates can be approximately calculated:

$$1 / Tg = {\sum }_{n = 1}^{n = x} Wn / {Tg}_{n} ; {\sum }_{n}^{} {W}_{n} = 1$$

Tg=glass transition temperature of the poly(meth)acrylate;
Wₙ=weight fraction of the nth monomer;
Tgₙ=glass transition temperature of the homopolymer of the nth monomer; and
x=number of different monomers.

The process for preparing the (meth)acrylate copolymers for use in accordance with the invention has no particular technical features but instead takes place by means of the methods of continuous or batchwise free-radically initiated copolymerization that are conventional in the polymers field, in bulk, solution, emulsion, miniemulsion or microemulsion, under atmospheric or superatmospheric pressure, in stirred tanks, autoclaves, tube reactors, loop reactors or Taylor reactors, at temperatures of preferably from 50 to 200° C.

Examples of suitable copolymerization processes are described in patent applications DE 197 09 465 A1, DE 197 09 476 A1, DE 28 48 906 A1, DE 195 24 182 A1, DE 198 28 742 A1, DE 196 28 143 A1, DE 196 28 142 A1, EP 0 554 783 A1, WO 95/27742, WO 82/02387 or WO 98/02466. Alternatively the copolymerization can be conducted in polyols as the reaction medium, as described for example in German patent application DE 198 50 243 A1.

Examples of suitable free-radical initiators are dialkyl peroxides, such as di-tert-butyl peroxide or dicumyl peroxide; hydroperoxides, such as cumene hydroperoxide or tert-butyl hydroperoxide; peresters, such as tert-butyl perbenzoate, tert-butyl perpivalate, tert-butyl per-3,5,5-trimethylhexanoate or tert-butyl per-2-ethylhexnoate; peroxodicarbonates; potassium, sodium or ammonium peroxodisulfate; azo initiators, examples being azodinitriles such as azobisiso-butyronitrile; C-C-cleaving initiators such as benzpinacol silyl ethers; or a combination of a nonoxidizing initiator with hydrogen peroxide. Combinations of the above-described initiators can also be used.

Further examples of suitable initiators are described in German patent application DE 196 28 142 A1, page 3, line 49 to page 4 line 6.

It is preferred to add comparatively large amounts of free-radical initiator, the initiator fraction of the reaction mixture, based in each case on the total amount of the monomers (a) and of the initiator, being with particular preference from 0.2 to 20% by weight, with very particular preference from 0.5 to 15% by weight, and in particular from 1.0 to 10% by weight.

Additionally it is possible to use thiocarbonylthio compounds or mercaptans such as dodecyl mercaptan as chain transfer agents or molecular weight regulators.

Further highly suitable oligomer and polymer binders are sold for example under the trade names Desmophen®650, 2089, 1100, 670, 1200 or 2017 by Bayer, under the trade names Priplas or Pripol® by Uniqema, under the trade names Chempol® polyester or polyacrylate-polyol by CCP, under the trade names Crodapol®0-25, 0-85 or 0-86 by Croda, or under the trade name Formrez®ER 417 by Witco.

The nature and amount of the reactive diluents and binders are preferably selected such that the dual cure compositions of the invention after they have been cured have a storage modulus E′ in the rubber-elastic range of at least 10^{7.5} Pa and a loss factor tanδ at 20° C. of not more than 0.10, the storage modulus E′ and the loss factor having been measured by means of dynamic mechanical thermoanalysis on free films having a thickness of 40±10 μm (cf. in this regard German Patent DE 197 09 467 C2).

The amount of the above-described reactive diluents and binders in components (I) may vary very widely and is guided in particular by the reactivity of these constituents, by the number of reactive functional groups they contain, and by the profile of performance properties intended for the dually cured compositions of the invention formed from the dual cure compositions prepared with the aid of the components (I) in question. The amount of the reactive diluents and binders, in particular the binders, in components (I) is preferably such that in the dual cure compositions of the invention the resultant amount of reactive diluents and binders, especially of binders, is from 10 to 80%, more preferably from 15 to 75%, with particular preference from 20 to 70%, with very particular preference from 25 to 65%, and in particular from 20 to 65% by weight, based in each case on the solids of the dual cure compositions of the invention.

Besides the constituents described above the components (I) may further comprise at least one conventional constituent selected from the group consisting of purely physically curing binders, different than the binders described above; crosslinking agents different than the below-described isocyanato acrylates and polyisocyanates; thermally curable reactive diluents; molecularly dispersely soluble dyes; light stabilizers, such as UV absorbers and reversible free-radical scavengers (HALS); antioxidants; devolatilizers; wetting agents; emulsifiers; slip additives; polymerization inhibitors; thermal crosslinking catalysts; thermolabile free-radical initiators; adhesion promoters; leveling agents; film-forming auxiliaries; rheological assistants, such as thickeners and pseudoplastic sag control agents, SCAs; flame retardants; corrosion inhibitors; free-flow aids; waxes; siccatives; biocides; and flatting agents.

These and other suitable constituents are described in the textbook “Lackadditive” [Additives for coatings] by Johan Bieleman, Wiley-VCH, Weinheim, N.Y., 1998, in D. Stoye and W. Freitag (editors), “Paints, Coatings and Solvents”, Second, Completely Revised Edition, Wiley-VCH, Weinheim, N.Y., 1998, “14.9 Solvent Groups”, pages 327 to 373.

The components (I) comprising the constituents described above are used in particular to prepare dual cure compositions of the invention, especially coating materials (more particularly clearcoat materials), adhesives, and sealants, and also precursors of moldings and films, which serve to produce clear, transparent dually cured compositions, especially coatings (more particularly clearcoats), adhesive bonds, seals, moldings, and films.

Alternatively the components (I) can be pigmented. In that case they preferably include at least one pigment selected from the group consisting of organic and inorganic transparent and opaque, color and/or effect, electrically conductive, magnetically shielding, and fluorescent pigments, fillers, and nanoparticles.

The pigmented components (I) are used in particular to prepare dual cure compositions, especially coating materials (more especially surfacers, basecoat materials, and solid-color topcoat materials), adhesives, and sealants, and also precursors of moldings and films, which serve to produce pigmented dually-cured compositions, especially coatings (more particularly surfacer coats and antistonechip primer coats, basecoats and solid-color topcoats), adhesive bonds, seals, moldings, and films.

Where exclusively nonopaque, transparent pigments, especially nanoparticles, are used, the pigmented components (I) can also be used to prepare clear, transparent dual cure compositions, especially coating materials (more particularly clearcoat materials), adhesives, and sealants, and also precursors of moldings and films.

In terms of its method the preparation of components (I) as part of the process of the invention has no special features but instead takes place by the mixing and homogenizing of the above-described constituents using conventional mixing techniques and apparatus such as stirred tanks, stirrer mills, extruders, compounders, Ultraturrax, inline dissolvers, static mixers, micromixers, toothed-wheel dispersers, pressure release nozzles and/or microfluidizers.

The systems of the invention comprise at least one mixture of the invention as component (II).

Component (II) of the systems of the invention is free of isocyanate-reactive functional groups. It contains isocyanate groups and none of the above-described groups activable with actinic radiation. Alternatively it contains isocyanate groups and the above-described groups activable with actinic radiation. The isocyanate groups or isocyanate and actinic-radiation-activable groups are the sole or predominant-preferably the sole-reactive functional groups in components (II).

“Predominant” means that the reactive functional groups in question make up more than 50, preferably more than 60, and in particular more than 70 equivalent %, based in each case on all of the reactive functional groups present in component (II).

The additional reactive functional groups, different than the above-described reactive functional groups, where present, are preferably non-isocyanate-reactive, thermally activable reactive functional groups, such as carboxyl groups, methylol ether groups, epoxide groups and/or blocked isocyanate groups, such as are normally used in one-component systems. It is preferred to use additional reactive functional groups which are complementary to the additional reactive functional groups present in components (I).

In component (II) the isocyanate groups may be present in any of a wide variety of constituents. They are preferably present in polyisocyanates.

In component (II) the above-described groups activable with actinic radiation, where present, can be in constituents other than the polyisocyanates. However, they are preferably present in the polyisocyanates. The especially preferred constituents in question are also referred to by those in the art as isocyanato acrylates.

The polyisocyanates are preferably selected from the group consisting of polyisocyanates containing on average at least 2.0 to 10, preferably 2.1 to 6, blocked isocyanate groups in the molecule. More preferably the polyisocyanates are selected from the group consisting of polyisocyanates containing on average per molecule at least one isocyanurate, biuret, allophanate, iminooxadiazinedione, urethane, urea, carbodiimide and/or uretdione group.

Examples of suitable polyisocyanates are known from German patent application DE 199 24 170 A1, column 3 line 61 to column 6 line 14 and column 10 line 60 to column 11 line 38, or from documents CA 2,163,591 A, U.S. Pat. No. 4,419,513 A, U.S. Pat. No. 4,454,317 A, EP 0 646 608 A1, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1, EP 0 531 820 A1or DE,100 05 228 A1. Also suitable are the high-viscosity polyisocyanates as described in German patent application DE 198 28 935 A1, the polyisocyanate particles deactivated on their surface by urea formation and/or blocking, in accordance with European patent applications EP 0 922 720 A1, EP 1 013 690 A1, and EP 1 029 879 A1, or nonyl triisocyanate (NTI). Additionally suitable are the adducts described by German patent application DE 196 09 617 A1, namely adducts of polyisocyanates with dioxanes, dioxolanes and oxazolidines, containing isocyanate-reactive functional groups, that still contain free isocyanate groups.

Examples of suitable isocyanato acrylates are described in European patent application EP 0 928 800 A1.

The polyisocyanates may also be partly blocked. Examples of suitable blocking agents for blocking some of the free isocyanate groups in the polyisocyanates and isocyanato acrylates are known from German patent application DE 199 24 170 A1, column 6 lines 19 to 53.

The nature and amount of polyisocyanates and isocyanato acrylates are preferably selected such that the dual cure compositions of the invention after they have been cured have a storage modulus E′ in the rubber-elastic range of at least 10^{7.5} Pa and a loss factor tanδ at 20° C. of not more than 0.10, the storage modulus E′ and the loss factor having been measured by means of dynamic mechanical thermoanalysis on free films having a thickness of 40±10 μm (cf. in this regard German patent DE 197 09 467 C2).

The amounts of the above-described polyisocyanates and isocyanato acrylates in components (II) may vary very widely and is guided in particular by the reactivity of these constituents, the number of reactive functional groups they contain, and the profile of performance properties intended for the dually cured compositions of the invention formed from the dual cure compositions prepared with the aid of the components (II) in question. The amount of the polyisocyanates and isocyanate acrylates in components (II) is preferably such that in the dual cure compositions of the invention the amount of polyisocyanates and isocyanato acrylates is from 5 to 50% by weight, more preferably from 6 to 45% by weight, with particular preference from 7 to 40% by weight, with very particular preference from 8 to 35% by weight, and in particular from 9 to 30% by weight, based in each case on the solids of the dual cure composition of the invention.

Besides the above-described constituents, including the photoinitiators, the components (II) may further comprise at least one conventional constituent selected from the group consisting of crosslinking agents free of isocyanate-reactive functional groups, other than the above-described isocyanato acrylates and polyisocyanates, and also of light stabilizers that are free of isocyanate-reactive functional groups, such as UV absorbers and reversible free-radical scavengers (HALS).

In terms of method the preparation of the mixtures of the invention or of components (II) as part of the process of the invention likewise has no special features but instead takes place by the mixing and homogenizing of the above-described constituents with the aid of the above-described, conventional mixing techniques and apparatus preferably in the absence of actinic radiation.

In the context of the process of the invention the systems of the invention are prepared by mixing at least one, especially one, component (I) and at least one, especially one component (II) and homogenizing the resulting mixtures. For this it is possible to use the customary and known mixing techniques and apparatus described above. It is preferred to operate in the absence of actinic radiation.

The quantitative proportion of component(s) (I) to component(s) (II) may vary very widely and is guided by the proportion of the reactive functional groups present in each case in components (I) and (II). The ratio (I):(II) is preferably chosen such that the equivalents ratio of isocyanate-reactive functional groups in component(s) (I) to the isocyanate groups in component(s) (II) is from 0.5:1 to 1:0.5, more preferably from 0.6:1 to 1:0.6, with particular preference from 0.7:1 to 1:0.7, with very particular preference from 0.8:1 to 1:0.8, and in particular from 0.9:1 to 1:0.9.

Surprisingly the above-described components (I) of the systems of the invention can be transported and/or stored for a long time even at relatively high temperatures, such as occur when they are container shipped in the summer, for example, and/or on prolonged storage outdoors, without losing their technological properties. They withstand even high and lasting shear forces such as occur, for example, during their preparation and processing particularly in the painting plant in circuits, in conveying apparatus, such as gear pumps, and/or during the grinding of pigmented components (I) in milling apparatus, leading to an increase in the temperature of the components (I) locally or overall. All in all there is no adverse change in the technological properties of components (I) on mechanical and/or thermal exposure, even when combined with exposure to light.

A particular surprise is that the mixtures of the invention and the above-described components (II) of the systems of the invention exhibit the same advantageous properties.

The advantageous properties, particularly the increased stability, of the above-described components (I) and (II) simplify the implementation of the process of the invention for preparing the systems of the invention, and do so logistically, technically, and economically. In particular the systems of the invention are of outstanding reproducibility with the aid of the process of the invention.

The dual cure compositions of the invention prepared from the systems of the invention combine a high reactivity with a very good pot life or processing time of several hours up to one working day, which makes their further processing much easier. As a result the dual cure compositions of the invention can be used with particular advantage diversely as pigmented and unpigmented coating materials, adhesives, sealants, and precursors of moldings and films, preferably coating materials, especially clearcoat materials, surfacers, basecoat materials, and solid-color topcoat materials.

The dual cure compositions of the invention serve to produce dually cured compositions of the invention, preferably coatings, adhesive bonds, seals, moldings and films, more preferably coatings, with particular preference clearcoats, surface coats or antistonechip primer coats, basecoats, and solid-color topcoats, with very particular preference clearcoats, and especially clearcoats of multicoat color and/or effect paint systems produced by the conventional wet-on-wet techniques.

To produce the dually cured compositions of the invention the dual cure compositions of the invention are applied to conventional temporary or permanent substrates.

For producing films and moldings of the invention it is preferred to use conventional temporary substrates, such as metal and polymer belts or hollow bodies of metal, glass, plastic, wood or ceramic, which are easily removed without damaging the films and moldings of the invention.

Where the dual cure compositions of the invention are used for producing coatings, adhesive bonds, and seals the substrates used are permanent, such as means of transport, including aircraft, ships, rail vehicles, muscle-powered vehicles, and motor vehicles, and parts thereof, the interior and exterior of buildings and parts thereof, doors, windows, furniture, hollow glassware, coils, freight containers, packaging, small parts, electrical components, and components for white goods. The films and moldings of the invention may likewise serve as substrates.

In terms of its method the application of the dual cure compositions of the invention has no special features but may instead take place by any conventional application method suitable for the composition in question, such as electrocoating, spraying, squirting, knife coating, brushing, pouring, dipping, trickling or rolling, for example. Preference is given to employing spray application methods.

During application it is advisable to operate in the absence of actinic radiation, in order to prevent premature crosslinking of the dual cure compositions.

The curing of the applied dual cure compositions of the invention takes place in general after a certain rest time or flash-off time. This may have a duration of from 30 seconds to 2 hours, preferably from 1 minute to 1 hour, and in particular from 1 to 45 minutes. The rest period serves, for example, for leveling and for the devolatilization of the applied dual cure compositions and for the evaporation of volatile constituents such as solvents and/or water. Flashing off can be accelerated by an elevated temperature, but below that which effects a cure, and/or by a reduced atmospheric humidity.

The thermal curing of the applied dual cure compositions of the invention may be effected for example with the aid of a gaseous, liquid and/or solid, hot medium, such as hot air, heated oil or heated rollers, or of microwave radiation, infrared light and/or near infrared light (NIR). Heating takes place preferably in a forced-air oven or by irradiation with IR and/or NIR lamps. As in the case of the actinic radiation cure the thermal cure as well may take place in stages. The thermal cure takes place with advantage at temperatures from room temperature to 200° C.

The applied dual cure compositions of the invention are preferably cured using UV radiation. During the irradiation it is preferred to employ a radiation dose of from 80 to 6 000, more preferably from 200 to 3 000, more preferably still from 300 to 1 500, and with particular preference from 500 to 1 200 mJ cm⁻², the region <1 200 mJ cm⁻² being especially preferred. The radiation intensity may vary widely. It is guided in particular by the radiation dose on the one hand and by the period of irradiation on the other. For a given radiation dose the period of irradiation is guided by the belt speed or the weight of advance of the substrates in the irradiation unit, and vice versa. The radiation intensity is preferably from 1×10⁰ to 3×10⁵, more preferably from 2×10⁰ to 2×10⁵, with particular preference from 3×10⁰ to 1.5×10⁵, and in particular from 5×10⁰ to 1.2×10⁵ W m⁻².

Examples of radiation sources used include high or medium pressure mercury vapor lamps, it being possible for the mercury vapor to be modified with other elements such as gallium or iron. Laser-pulsed lamps, which are known under the name UV flashlights, halogen lamps or excimer sources may likewise be used. The lamps and sources may be equipped with filters which prevent the emergence of part of the lamp spectrum emitted. For example, for occupational hygiene reasons, the radiation assigned to the UV-C region or to the UV-C and UV-B regions may be filtered out. Lamps and sources which emit only UV-A radiation and, possibly, longer-wave radiation can be put to advantageous use in particular where the risk to humans by high-energy UV radiation cannot be ruled out by means of other measures such as shielding.

The UV emitters or lamps, especially the UV-A emitters or lamps, can be installed stationary or mobile, so that the articles to be irradiated can be moved past the radiation source by mechanical devices or the UV emitters or lamps can be guided over the stationary articles to be irradiated.

Suitable UV-A emitters or lamps are sold for example by Panacol-Elosol GmbH, Oberursel, Federal Republic of Germany, under the designation UV-H 254, Quick-Start UV 1200, UV-F 450, UV-P 250C, UV-P 280/6 or UV-F 900. Further suitable UV emitters or lamps are known from R. Stephen Davidson, “Exploring the Science, Technology and Applications of U.V. and E.B. Curing” Sita Technology Ltd., London, 1999, Chapter I, “An Overview”, page 16, FIG. 10, or Dipl.-Ing. Peter Klamann, “eltosch System-Kompetenz, UV-Technik, Leitfaden für Anwender”[Eltosch systems expertise, UV technology, guide for users], page 2, Oct. 1998. Suitable flashlamps are flashlamps from the company VISIT.

The distance of the applied dual cure compositions of the invention that are to be irradiated may vary surprisingly widely and may therefore be tailored very effectively to the requirements of the case in hand. The distance is preferably from 2 to 200, more preferably from 5 to 100, very preferably from 10 to 50, and in particular from 15 to 30 cm. Their arrangement may also be adapted to the circumstances of the substrate and the process parameters. In the case of substrates of complex shape, such as are envisaged for automobile bodies, those areas not accessible to direct radiation (shadow regions), such as cavities, folds, and other structural undercuts, may be cured using pointwise, small-area or all-round emitters, in conjunction with an automatic movement means for the irradiation of cavities or edges. Irradiation is preferably conducted under an oxygen-depleted atmosphere or in complete absence of oxygen, i.e., under an inert gas atmosphere.

“Oxygen-depleted” denotes that the oxygen content of the atmosphere is lower than the oxygen content of air (20.95% by volume). The maximum oxygen content of the oxygen-depleted atmosphere is preferably 18%, more preferably 16%, very preferably 14%, with very particular preference 10%, and in particular 6.0% by volume.

By inert gas is meant a gas which under the curing conditions employed is not decomposed by the actinic radiation, does not inhibit the cure, and does not react with the applied dual cure compositions of the invention. Preference is given to using nitrogen, carbon dioxide, combustion gases, helium, neon or argon, especially nitrogen and/or carbon dioxide.

The applied dual cure compositions of the invention can also be irradiated while covered with media which are transparent for the actinic radiation, which are not decomposed by the actinic radiation under the curing conditions employed, do not inhibit the cure, and do not react with the applied dual cure compositions of the invention. Examples of suitable media are plastic films, glass or liquids such as water.

Both the thermal cure and the actinic radiation cure can be carried out in stages. In this case they may take place one after another (sequentially) or simultaneously.

Sequential curing is of advantage in accordance with the invention and is therefore used with preference. It is advantageous to carry out the thermal cure after the actinic radiation cure.

The resultant films, moldings, coatings, adhesive bonds, and seals of the invention are outstandingly suitable for the coating, adhesive bonding, sealing, wrapping, and packing of means of transport, including aircraft, ships, rail vehicles, muscle-powered vehicles and motor vehicles, and parts thereof, the interior and exterior of buildings and parts thereof, doors, windows, furniture, hollow glassware, coils, freight containers, packaging, small parts, such as nuts, bolts, wheel rims or hub caps, electrical components, such a windings (coils, stators, rotors), and components for white goods, such as radiators, household appliances, refrigerator casings or washing machine casings.

The substrates of the invention coated with coatings of the invention, bonded with adhesive bonds of the invention, sealed with seals of the invention and/or wrapped or packed with films and/or moldings of the invention have outstanding long-term service properties and a particularly long service life.

### EXAMPLES

### Preparation Example 1

### The Preparation of a Methacrylate Copolymer

A suitable reactor equipped with a stirrer, two dropping funnels for the monomer mixture and the initiator solution, nitrogen inlet tube, thermometer, heating, and reflux condenser, was charged with 650 parts by weight of an aromatic hydrocarbon fraction having a boiling range of from 158 to 172° C. The solvent was heated to 140° C. Thereafter a monomer mixture of 652 parts by weight of ethylhexyl acrylate, 383 parts by weight of 2-hydroxyethyl methacrylate, 143 parts by weight of styrene, 212 parts by weight of 4-hydroxybutyl acrylate and 21 parts by weight of acrylic acid was metered into the initial charger at a uniform rate over the course of four hours and an initiator solution of 113 parts by weight of the aromatic solvent and 113 parts by weight of tert-butyl polyethylhexanoate was metered into the initial charge at a uniform rate over the course of 4.5 hours. The addition of the monomer mixture and of the initiator solution was commenced simultaneously. After the end of the initiator feed the resulting reaction mixture was heated at 140° C. with stirring for two hours more and then cooled. The resulting solution of the methacrylate copolymer (A) was diluted with a mixture of 1-methoxypropyl 2-acetate, butylglycol acetate, and butyl acetate.

The resulting solution had a solids content of 65% by weight, determined in a forced air oven (one hour/130° C.), an acid number of 15 mg/KOH/g solids, an OH number of 175 mg KOH/g solids, and a glass transition temperature of −21 ° C.

### Examples 1 (Inventive) and C1 (Comparative)

### Preparation of components I (example 1) and C1 (example C1)

Components I (example 1) and C1 (example C1) were prepared by mixing the constituents indicated in the table in the order stated and homogenizing the resulting mixtures.

TABLE
The composition of components I
(example 1) and C1 (example C1)

| | Parts by | |
|---|---|---|
| | weight | |
| | Components: | |
| Ingredient | C1 | 1 |
| Methacrylate copolymer of preparation example 1 | 35.9 | 35.9 |
| Dipentaerythritol pentaacrylate | 20 | 20 |
| UV absorber (substituted hydroxyphenyltriazine) | 1.0 | 1.0 |
| HALS (N-methyl-2,2,6,6-tetramethylpiperidyl ester) | 1.0 | 1.0 |
| Wetting agent (Byk ® 306 from Byk Chemie) | 0.4 | 0.4 |
| Butyl acetate | 27.4 | 29.2 |
| Solventnaphtha ® | 10.8 | 12.5 |
| Irgacure ® 184 (commercial photoinitiator from | 2.0 | — |
| Ciba Specialty Chemicals) | | |
| Genocure ® MBF (commercial photoinitiator from | 1.0 | — |
| Rahn) | | |
| Lucirin ® TPO (commercial photoinitiator from | 0.5 | — |
| BASF AG) | | |
| Total: | 100 | 100 |

Components I and C1 were dispensed into pale glass bottles and stored at 8° C., room temperature (RT), and 40° C. in daylight and in the dark. The samples were designated as follows:
Series I-1: I-1 (8° C./light), I-1 (RT/light), I-1 (40° C./light);
Series I-2: I-2 (8° C./dark), 1-2 (RT/dark), 1-2 (40° C./dark);
Series C1-1: C1-1(8° C./light), C1-1(RT/light), C1-1(40° C./light); and
Series C1-2: C1-2 (8° C./dark), C1-2 (RT/dark), C1-2 (40° C./dark).

Whereas components I even after 28 days of storage in the light and in the dark (series I-1 and I-2) showed no changes, the samples of series C1-1 had gelled completely after just a short time: C1-1 (8° C./light): 10 days; C1-1 (RT/light): 3 days; C1-1 (40° C./light): 1 day. In the case of sample C1-2 (40° C./dark) of series C1-2 there was a significant increase in the viscosity; only the samples C1-2 (8° C./dark) and C1-2 (RT/dark) showed only minimal increases in viscosity after 28 days.

Consequently, a considerably greater effort was required for component C1than for component I, in terms of the conditions of storage and of transit, in order for them to remain usable.

### Examples 2 (inventive) and C2 (comparative)

### Preparation of components II (example 2) and C2 (example C2)

Components II (example 2) and C2 (example C2) were prepared by mixing the ingredients indicated in the table in the stated order and homogenizing the resulting mixtures.

TABLE
The composition of components II
(example 2) and C2 (example C2)

| | Parts by | |
|---|---|---|
| | weight | |
| | Components: | |
| Ingredient | II | C2 |
| Isocyanato acrylate Roskydal ® UA VPLS 2337 from | 27.84 | 27.84 |
| Bayer AG (basis: trimeric hexamethylene | | |
| diisocyanate; isocyanate group content: 12% by | | |
| weight) | | |
| Isocyanato acrylate based on the trimer of | 6.96 | 6.96 |
| isophorone diisocyanate (70.5% in butyl acetate; | | |
| viscosity: 1 500 mPas; isocyanate group content: | | |
| 6.7% by weight; prepared in analogy to example 1 | | |
| of EP 0 928 800 A1) | | |
| Diluent | 3.48 | 5.98 |
| Irgacure ® 184 (photoinitiator from Ciba | 2.0 | — |
| Specialty Chemicals) | | |
| Genocure ® MBF (commercial photoinitiator from | 1.0 | — |
| Rahn) | | |
| Lucirin ® TPO (commercial photoinitiator from | 0.5 | — |
| BASF AG) | | |
| Total: | 40.78 | 40.78 |

Components II and C2 were dispensed into glass bottles and stored in the dark at 60° C. Component C2 showed no increase in viscosity even after 28 days. Surprisingly this was also the case for component II.

Consequently it was demonstrated that the inventive system of component I of example 1 and component II of example 2 was completely stable on storage without great expense, in contrast to the system of component C1 of example C1 and component C2 of example C2.

### Examples 3 (inventive) and C3 (comparative)

### The preparation of clearcoat matierals (I+II) (example 3) and (C1+C2) (example C3) and production of multicoat paint systems from them

For example 3 100 parts by weight of component I-1 (40° C./light) (storage time 28 days) from example 1 and 40.78 parts by weight of component II (storage time 28 days at 60° C.) from example 2 were used.

For example C3 100 parts by weight of the freshly prepared component C1 from example C1 and 40.78 parts by weight of the freshly prepared component C2 from example C2 were used.

After the respective components had been mixed the resulting clearcoat materials were homogenized.

To produce the multicoat paint systems, steel panels were coated in succession with cathodically deposited electrocoats baked at 170° C. for 20 minutes, in a dry film thickness of 18 to 22 μm. Thereafter the steel panels were coated with a commercial two-component water-based surfacer from BASF Coatings AG, such as is commonly used for substrates of plastic. The resultant surfacer films were baked at 90° C. for 30 minutes to give a dry film thickness of 35 to 40 μm. Thereafter a commercial black aqueous basecoat material from BASF Coatings AG was applied with a film thickness of 12 to 15 μm, after which the resulting aqueous basecoat films were flashed off at 80° C. for ten minutes. Subsequently the clearcoat materials (I+II) and (C1+C2) were applied pneumatically using a gravity-feed cup-type gun in one cross pass with a film thickness of 40 to 45 μm. The aqueous basecoat films and clearcoat films were cured at room temperature for 5 minutes, at 80° C. for 10 minutes, followed by UV irradiation in a dose of 1 500 mJ/cm², and finally at 140° C. for 20 minutes. In the course of curing with UV radiation an oxygen-depleted atmosphere composed of air and nitrogen with 5% by volume oxygen was employed.

Surprisingly the multicoat paint systems of example 1 and of example C3 had essentially the same outstanding profile of properties.

They were very bright and had a gloss (20 °) to DIN 67530 of 90. The micropenetration hardness (universal hardness at 25.6 mN, Fischerscope 100V with Vickers diamond pyramid) was 138.

The scratch resistance was assessed using the sand test (cf. German patent application DE 198 39 453 A1, page 9 lines 1 to 63) on the basis of the metal test panels described above. The loss of gloss was only 3.5 units (20°).

The scratch resistance was also assessed using the brush test (cf. German patent application DE 198 39 453 A1, page 9 lines 17 to 63) on the basis of the metal test panels described above. The loss of gloss after damaging was only 1.5 units (20°).

In the case of the DaimlerChrysler gradient oven test, which is known to those in the art, the first damage to the multicoat paint systems by sulfuric acid occurred only at a temperature of 53° C. and that by tree resin only from 55° Celsius onward. The etch resistance was also outstanding.

Both multicoat paint systems exhibited outstanding leveling and were free from surface defects, such as bits, pops, and pinholes.

This underlines the fact that the clearcoat material (I+II) of example 3, prepared from the thermally and radiation-stressed component I of example 1, was completely equivalent to the clearcoat material (C1+C2) of example C3 which was prepared from the freshly prepared component C1 of example C1 which had undergone neither radiation nor thermal stressing.

1. A mixture free of isocyanate-reactive functional groups, containing at least one of
isocyanate groups and no groups activable with actinic radiation and
isocyanate groups and groups activable with actinic radiation
as the sole or predominant reactive functional groups and also at least one initiator activable by actinic radiation.

2. A mixture as claimed in claim 1, wherein the actinic radiation is UV radiation or electron beams.

3. A mixture as claimed in claim 1, wherein the initiator activable with actinic radiation is a photoinitiator.

4. A mixture as claimed in claim 3, wherein the photoinitiator is selected from the group consisting of unimolecular (type I) and bimolecular (type II) photoinitiators.

5. A mixture as claimed in claim 4, wherein the photoinitiator of type I is selected from the group consisting of benzophenones in combination with tertiary amines, alkylbenzophenones, 4,4′-bis(dimethylamino)benzophenone (Michler's ketone), anthrone, and halogenated benzophenones, and the photoinitiator of type II is selected from the group consisting of benzoins, benzoin derivatives, especially benzoin ethers, benzil ketals, acylphosphine oxides, especially 2,4,6-trimethylbenzoyldiphenylphosphine oxide, bisacylphosphine oxides, phenylglyoxylic esters, camphorquinone, alpha-aminoalkylphenones, alpha,alpha-dialkoxyacetophenones, and alpha-hydroxyalkylphenones.

6. A mixture as claimed in claim 1, wherein the groups activable with actinic radiation contain at least one bond which can be activated with actinic radiation.

7. A mixture as claimed in claim 6, wherein the bond which can be activated with actinic radiation is selected from the group consisting of carbon-hydrogen and carbon-halogen single bonds, carbon-carbon, carbon-oxygen, carbon-nitrogen, carbon-phosphorus, and carbon-silicon single bonds and double bonds, and carbon-carbon triple bonds.

8. A mixture as claimed in claim 7, wherein the bond which can be activated with actinic radiation is a carbon-carbon double bond.

9. A mixture as claimed in claim 8, wherein the bond which can be activated with actinic radiation is present in a group activable with actinic radiation, selected from the group consisting of (meth)acrylate, ethacrylate, crotonate, cinnamate, vinyl ether, vinyl ester, dicyclopentadienyl, norbomenyl, isoprenyl, isopropenyl, allyl, and butenyl groups; dicyclopentadienyl ether, norbomenyl ether, isoprenyl ether, isopropenyl ether, allyl ether, and butenyl ether groups; and dicyclopentadienyl ester, norbomenyl ester, isoprenyl ester, isopropenyl ester, allyl ester, and butenyl ester groups.

10. A mixture as claimed in claim 9, wherein the group which can be activated with actinic radiation is an acrylate group.

11. A mixture as claimed in claim 1, wherein the isocyanate-reactive functional groups are selected from the group consisting of hydroxyl groups, thiol groups, primary and secondary amino groups, and imino groups.

12. A mixture as claimed in claim 1, wherein the isocyanate groups or the isocyanate groups and the groups which can be activated with actinic radiation are the sole reactive functional groups present in the mixture.

13. A crosslinking component of a two component or multi component system comprising as a crossslinking component a mixture as claimed in claim 1 and comprising at least one initiator activable by actinic radiation.

14. A two-component or multi-component system comprising at least one initiator activable by actinic radiation and comprising
(I) at least one component free of isocyanate groups, containing groups activable with actinic radiation and isocyanate-reactive functional groups as the sole or predominant reactive functional groups and
(II) at least one component free of isocyanate-reactive functional groups and comprising
isocyanate groups and no groups activable with actinic radiation or
isocyanate groups and groups activable with actinic radiation, as the sole or predominant functional groups,
in which all or most of the initiator activable with actinic radiation is present in component(s) (II).

15. A system as claimed in claim 14, wherein all of the initiator activable by actinic radiation is present in component(s) (II).

16. A system as claimed in claim 14, wherein the groups which can be activated with actinic radiation and the isocyanate-reactive functional groups are the sole reactive functional groups present in component(s) (I).

17. A system as claimed in claim 14, wherein the isocyanate groups or the isocyanate groups and the groups which can be activated with actinic radiation are the sole reactive functional groups present in component(s) (II).

18. The system as claimed in claim 14, wherein the equivalents ratio of isocyanate-reactive functional groups in component(s) (I) to the isocyanate groups in component(s) (II) is from 0.5:1 to 1:0.5.

19. A process for preparing a two-component or multicomponent system comprising at least one initiator activable by actinic radiation comprising separately preparing components (I) and (II) of wherein components (I) and (II) comprise
(I) at least one component free of isocyanate groups, containing groups activable with actinic radiation and isocyanate-reactive functional groups as the sole or predominant reactive functional groups and
(II) at least one component free of isocyanate-reactive functional groups and containing
isocyanate groups and no groups activable with actinic radiation or
isocyanate groups and groups activable with actinic radiation
as the sole or predominant reactive functional groups
and adding all or most of the initiator activable by actinic radiation to component(s) (II).

20. (canceled)

21. (canceled)

22. (canceled)

23. (canceled)

24. (canceled)

25. A coating comprising a system as claimed in claim 14, wherein said coating is cured thermally and with actinic radiation.

26. A coating as claimed in claim 25 comprising a clearcoat coating.

27. A coating as claimed in claim 25 comprising at least one of a muticoat color paint system and an effect paint system.

28. A composition selected from the group consisting of adhesives, sealants and precursors of films and precursors of moldings, comprising the system as claimed in claim 14.
